(19) United States
(12) Patent Application Publication
(10) Pub. No.: US 2022/0013012 A1
(43) Pub. Date: Jan. 13, 2022

(54) VEHICLE PARKING ASSISTANCE

(71) Applicant: Toyota Motor Engineering & Manufacturing North America, Inc., Plano, TX (US)

(72) Inventors: Takamasa Higuchi, Mountain View, CA (US); Kentaro Oguchi, Mountain View, CA (US)

(21) Appl. No.: 16/926,127

(22) Filed: Jul. 10, 2020

(51) Int. Cl. G08G 1/14; B60W 30/06

(52) U.S. Cl. CPC G08G 1/143; B60W 30/06; G08G 1/148

(57) ABSTRACT

An ego vehicle can be assisted when parking in a parking area. One or more sensors can be configured to acquire environment data of at least a portion of an external environment of the ego vehicle. The environment data can include at least a portion of the parking area. Parking availability data can be acquired for at least a portion of the parking area. The parking availability data can include a plurality of parking spaces and one or more vehicles parked in one or more of the parking spaces. The parking availability data can further include one or more attributes of the vehicles parked in the parking spaces. A current location of the ego vehicle within the parking area can be determined based on at least the parking availability data and the environment data.

### FIELD

The subject matter described herein relates in general to vehicles and, more particularly, to assisting vehicles or vehicle drivers in parking scenarios.

### BACKGROUND

Some vehicles include sensors that are configured to detect information about the surrounding environment. As an example, some vehicles can include sensors that can detect the presence of other vehicles and objects in the environment, as well as information about the detected vehicles and objects. Further, some vehicles can include computing systems that can process the detected information for various purposes.

### SUMMARY

In one respect, the subject matter presented herein relates to a parking assistance method. The method can include acquiring parking availability data for at least a portion of a parking area. The parking availability data can include data about a plurality of parking spaces in the parking area and data about one or more vehicles parked in one or more of the plurality of parking spaces. The parking availability data can further include one or more attributes of the one or more vehicles parked in the one or more of the plurality of parking spaces. The method can include acquiring, using one or more sensors, environment data of at least a portion of an external environment of an ego vehicle. The environment data can include at least a portion of the parking area. The method can include determining a current location of the ego vehicle within the parking area based on at least the parking availability data and the environment data.

In another respect, the subject matter presented herein relates to a parking assistance system. The system can include one or more sensors. The one or more sensors can be configured to acquire environment data of at least a portion of an external environment of an ego vehicle. The environment data can include at least a portion of a parking area. The system can include one or more processors. The one or more processors can be programmed to initiate executable operations that include acquiring parking availability data for at least a portion of the parking area. The parking availability data can include data about a plurality of parking spaces and data about one or more vehicles parked in one or more of the plurality of parking spaces. The parking availability data can further include one or more attributes of the one or more vehicles parked in the one or more of the plurality of parking spaces. The executable operations can include determining a current location of the ego vehicle within the parking area based on at least the parking availability data and the environment data.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 is an example of a parking assistance system.

FIG. 2 is an example of an ego vehicle.

FIG. 3 is an example of a server.

FIG. 4 is an example of a parking assistance method.

FIG. 5 is an example of a parking assistance scenario.

### DETAILED DESCRIPTION

A vehicle travelling through a parking area may be unable to determine its location within the parking area and/or its location relative to available parking spaces. The vehicle may be unable to determine its location using a global positioning system for multiple reasons, such as having a non-functioning or resolution-limited GPS device, and/or being located in an enclosed parking structure in which GPS and other signal quality may be reduced. In such a case, the vehicle may encounter difficulty navigating through the parking area to an available parking space.

According to arrangements herein, the vehicle and/or a server can use parking availability data and/or environment data received from different remote sources (e.g., vehicles, servers, databases, etc.) at different moments in time. The parking availability data, which can be in a map form, can include information about the parking area, and more specifically, about vacant parking spaces, occupied parking spaces, and parked vehicles in the parking area. The environment data can be acquired by sensors in or on the vehicle. The vehicle and/or the server can align the environment data with the parking availability data to determine a current location of the vehicle within the parking area. For instance, the vehicle and/or the server can align objects such as parked vehicles and infrastructure common to the environment data and the parking availability data so as to determine and track the current location of the vehicle. Further, the vehicle can identify available parking spaces in the parking area and can navigate to the one of the available parking spaces based on the current location of the vehicle, the environment data, and the parking availability data.

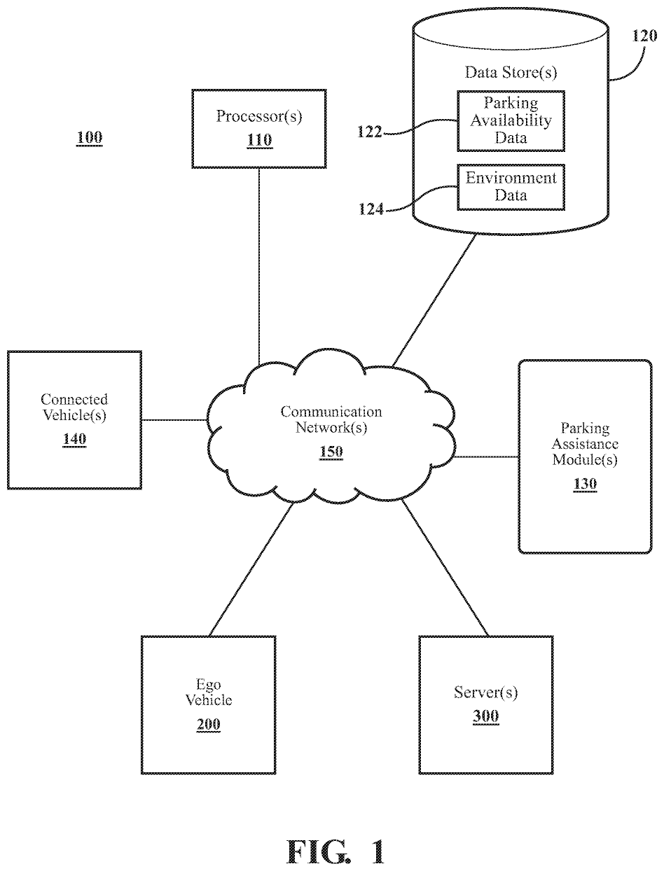

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-5, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

FIG. 1 is an example of a parking assistance (PA) system 100. Some of the possible elements of the PA system 100 are shown in FIG. 1 and will now be described. It will be understood that it is not necessary for the PA system 100 to have all of the elements shown in FIG. 1 or described herein. Moreover, the PA system 100 can have additional elements to those shown in FIG. 1. The PA system 100 can include a one or more processors 110, one or more data stores 120, one or more parking assistance module(s) 130, one or more connected vehicles 140, an ego vehicle 200, and/or one or more servers 300.

The various elements of the parking assistance system 100 can be communicatively linked through one or more communication networks 150. As used herein, the term “communicatively linked” can include direct or indirect connections through a communication channel or pathway or another component or system. A “communication network” means one or more components designed to transmit and/or receive information from one source to another. The communication network(s) 150 can be implemented as, or include, without limitation, a wide area network (WAN), a local area network (LAN), the Public Switched Telephone Network (PSTN), a wireless network, a mobile network, a Virtual Private Network (VPN), the Internet, and/or one or more intranets. The communication network(s) 150 further can be implemented as or include one or more wireless networks, whether short or long range. For example, in terms of short range wireless networks, the communication network(s) 150 can include a local wireless network built using a Bluetooth or one of the IEEE 802 wireless communication protocols, e.g., 802.11a/b/g/i, 802.15, 802.16, 802.20, Wi-Fi Protected Access (WPA), or Wi-Fi Protected Access (WPA2). The short range wireless network can be operatively connected to the parking area. In terms of long range wireless networks, the communication network(s) 150 can include a mobile, cellular, and or satellite-based wireless network and support voice, video, text, and/or any combination thereof. Examples of long range wireless networks can include GSM, TDMA, CDMA, WCDMA networks or the like. The communication network(s) 150 can include wired communication links and/or wireless communication links. The communication network(s) 150 can include any combination of the above networks and/or other types of networks. The communication network(s) 150 can include one or more routers, switches, access points, wireless access points, and/or the like. In one or more arrangements, the communication network(s) 150 can include Vehicle-to-Vehicle (V2V), Vehicle-to-Infrastructure (V2I), or Vehicle-to-Everything (V2X) technology, which can allow for communications between the ego vehicle 200 and the server(s) 300 and/or the connected vehicle(s) 140. One or more elements of the PA system 100 include and/or can execute suitable communication software, which enables two or more of the elements to communicate with each other through the communication network(s) 150 and perform the functions disclosed herein.

The PA system 100 can include one or more processors 110. “Processor” means any component or group of components that are configured to execute any of the processes described herein or any form of instructions to carry out such processes or cause such processes to be performed. The processor(s) 110 can be implemented with one or more general-purpose and/or one or more special-purpose processors. Examples of suitable processors include microprocessors, microcontrollers, DSP processors, and other circuitry that can execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The processor(s) 110 can include at least one hardware circuit (e.g., an integrated circuit) configured to carry out instructions contained in program code. In arrangements in which there is a plurality of processors 110, such processors can work independently from each other or one or more processors 110 can work in combination with each other. In one or more arrangements, one or more processors 110 can be a main processor(s) of a vehicle. For instance, one or more processors 110 can be electronic control unit(s) (ECU).

The PA system 100 can include one or more data stores 120 for storing one or more types of data. The data store(s) 120 can include volatile and/or non-volatile memory. Examples of suitable data stores 120 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 120 can be a component of the processor(s) 110, or the data store(s) 120 can be operatively connected to the processor(s) 110 for use thereby. The term “operatively connected,” as used throughout this description, can include direct or indirect connections, including connections without direct physical contact.

In one or more arrangements, the data store(s) 120 can include environment data 124. The environment data 124 can include information or data on at least a portion of an external environment of the ego vehicle 200. In a case where the ego vehicle 200 is in a parking area, the external environment can include information or data about at least a portion of the parking area. The environment data 124 can include information about the objects in the parking area such as mobile objects (e.g., moving vehicles) and stationary objects (e.g., parked vehicles and infrastructure).

The environment data 124 can be in any suitable form. As an example, the environment data can include images of objects detected in the parking area. The environment data 124 can include data in a text format and/or in a tabulated format. The environment data 124 can be raw sensor data. The environment data 124 can be acquired using one or more sensors of the ego vehicle 200. The sensor(s) in the ego vehicle 200 are described in detail below. In some arrangements, the environment data 124 can be acquired using one or more sensors of the connected vehicles 140.

The parking area can be any type of area where vehicles can be parked, now known or later developed. In one or more arrangements, the parking area can be a sheltered parking area. In such a case, there can be a roof over the parking area, or the parking area can be at least partially enclosed. The parking area can be an above ground and/or below ground parking structure. In other arrangements, the parking area can be outdoor parking area or an open parking area with no shelter or covering, such as a surface lot. The parking area can be multileveled with parking spaces on multiple levels (e.g., two or more levels). The parking area can have markings demarcating the parking spaces. The parking spaces can be identified by any suitable symbols and/or alphanumeric characters. The parking area can have infrastructure such as pillars, speed-bumps, ramps, etc. Further, the parking area can include markings that provide information to the vehicle and/or vehicle driver. The markings can indicate a direction of vehicle travel, the floor levels, parking zones, restricted and inaccessible areas, low ceiling, etc.

In one or more arrangements, the data store(s) 120 can include parking availability data 122. The parking availability data 122 can include information or data about at least a portion of a parking area. The parking availability data 122 can be in any suitable form. In some instances, the parking availability data 122 can be a map. In some instance, the parking availability data 122 can include aerial or overhead views or representations of the parking area. The parking availability data 122 can include a digital map with information about parking area geometry. In one or more arrangements, the parking availability data 122 can include information about the ground, terrain, roads, surfaces, and/or other features of at least a portion of the parking area. The parking availability data 122 can include elevation data for the parking area. In the case that the parking area includes multiple levels, the parking availability data 122 can include one or more portions of a single level, and/or one or more portions of multiple levels.

In some instances, the parking availability data 122 can include ground views of the parking area, including 360 degree ground views. The parking availability data 122 can include measurements, dimensions, distances, positions, coordinates, and/or information for one or more items included in the parking availability data 122 and/or relative to other items included in the parking availability data 122. The parking availability data can include information about one or more parking spaces in the parking area, such as images of the parking spaces and/or parking space identifiers. Parking space identifiers can include one or more symbols or alphanumeric characters that identify a parking space. The parking availability data 122 can be high quality and/or highly detailed.

The parking availability data 122 can include information about one or more environment landmarks. An environment landmark is a landmark or a feature that can be used to identify a location in the parking area. As an example, the environment landmark(s) can include structures in the parking areas such as pillars, ramps, corners, speed bumps, ventilation ducts, and barriers. The environment landmark(s) can include markings on the ground, at parking spaces, and on structures such as walls, barriers, ceilings, and pillars.

The parking availability data 122 can include information about driving rules within the parking area and/or additional information about driving lanes in the parking areas, such as whether a driving lane is one-way or two-way, a driving direction of a one-way driving lane, and/or a speed limit. As an example, the parking availability data 122 can include parking space lines, parking space numbers, traffic signs, sign boards, and stop signs, similar to the parking area.

The parking availability data 122 can include information identifying parking spaces that are vacant and/or available and parking spaces that are occupied. The parking availability data 122 can include information about the parking spaces such as restricted parking, handicap parking, reserved parking, electric vehicle parking, small cars only parking, etc.

The parking availability data 122 can include information about one or more vehicles parked in the parking spaces. The information about the vehicles can include one or more attributes of the vehicles. An attribute of a parked vehicle can include a visual characteristic of the parked vehicle such as a vehicle parking space identifier, a vehicle color, a vehicle type, a vehicle make, a vehicle model, a vehicle orientation, and a vehicle license plate number. The vehicle parking space identifier can be the parking space identifier identifying the parking space occupied by the parked vehicle. The vehicle color of the parked vehicle can include one or more exterior colors of the parked vehicle. The vehicle type can include the size of the vehicle, e.g., small-sized, medium sized, large-sized. The vehicle type can include a type such as sedan, hatchback, SUV, pickup truck, minivan, etc. The vehicle make can include the brand and/or the manufacturer of the vehicle. The vehicle model can include a model name and/or a model number for the vehicle. The vehicle orientation can include the direction the parked vehicle is facing. The vehicle license plate number can include symbols and/or alphanumeric characters on the vehicle's license plate. The vehicle license plate number can also include information about the issuing state of country of the license plate. The parking availability data in map format can illustrate the parked vehicle(s) with a graphical representation of the parked vehicle in the associated parking space. The graphical representation can include attributes of the parked vehicle such as color of the vehicle and the direction the vehicle is facing. As an alternative and/or in addition, the parking availability data 122 can illustrate the parked vehicle(s) with text on the associated parking space. For instance, the parking availability data can have “(occupied, black, forward)” associated with a parking space to indicate that the parking spacing that is occupied by a black colored, forward-facing vehicle. As another example, the parking availability data can have “(occupied, red, rearward)” associated with a parking space to indicate that the parking spacing that is occupied by a red colored, rearward-facing vehicle.

The parking availability data 122 can be generated and/or maintained by the server(s) 300. In one or more arrangements, the server(s) 300 can receive portions of the parking availability data 122 from external map database(s). The parking availability data 122 can be updated based on the environment data 124. The updated parking availability data 122 can be transmitted to the ego vehicle 200, the server 300, and/or the connected vehicle 140.

The PA system 100 can include an ego vehicle 200. The ego vehicle 200 can be a connected vehicle. A connected vehicle can be any vehicle that is communicatively coupled to other vehicles and/or to the server 300. In addition to the ego vehicle 200, the PA system 100 can include one or more connected vehicle(s) 140. As used in connection with the ego vehicle 200 and the connected vehicle(s) 140, the term “vehicle” means any form of motorized transport, now known or later developed. Non-limiting examples of vehicles include automobiles, motorcycles, aerocars, or any other form of motorized transport. While arrangements herein will be described in connection with land-based vehicles, it will be appreciated that arrangements are not limited to land-based vehicles. Indeed, in some arrangements, the vehicle can be water-based or air-based vehicles. The ego vehicle 200 and/or the connected vehicle(s) 140 may be operated manually by a human driver, semi-autonomously by a mix of manual inputs from a human driver and autonomous inputs by one or more vehicle computers, fully autonomously by one or more vehicle computers, or any combination thereof.

The PA system 100 can include one or more servers 300. In some arrangements, the server(s) 300 can be cloud-based server(s). The server(s) 300 can communicate with the ego vehicle 200 and/or with one or more connected vehicles 140 over the communication network 150, such as by any type of vehicle-to-cloud (V2C) communications, now known or later developed. The server(s) 300 can communicate with other servers. The server(s) 300 can receive parking availability data from other server(s) such as a parking area map database, the ego vehicle 200, and/or the connected vehicles 140. Additionally or alternatively, the server(s) 300 can transmit parking availability data 122 to other server(s), the ego vehicle 200 and/or the other connected vehicles 140. As another example, the parking availability data 122 can be generated and maintained by the server(s) 300.

In one or more arrangements, the parking assistance module(s) 130 can be configured to determine whether the ego vehicle 200 is within a predetermined distance of the parking area. As an example, the parking area can include one or more geo-fences surrounding the parking area. The geo-fence(s) can be at the predetermined distance around the parking area. In a case where the ego vehicle 200 traverses the geo-fence and is within the predetermined distance around the parking area, the geo-fencing service can notify the parking assistance module(s) 130. As another example, the parking area and/or the ego vehicle 200 can include one or more beacons, transponders, Radio-frequency identification (RFID) tags for detecting whether the ego vehicle 200 is within the predetermined distance of the parking area.

The parking assistance module(s) 130 can be configured to acquire the parking availability data 122 in response to the ego vehicle 200 being within the predetermined distance. Upon determining that an ego vehicle 200 is within the predetermined distance of the parking area, the parking assistance module(s) 130 receive the parking availability data 122 for the parking area. As an example, the parking assistance module(s) 130 receive the parking availability data 122 for the parking area from the server(s) 300 through the communication network(s) 150. The parking assistance module(s) 130 can request the parking availability data 122 or it can automatically be sent to the parking assistance module(s) 130 by the server(s) 300.

As another example, the geo-fencing service can notify the ego vehicle 200 that the ego vehicle 200 is within the geo-fenced area and is near the parking area. In response, the ego vehicle 200 can request and receive the parking availability data 122 from the server(s) 300. As another example, the geo-fencing service can notify the server(s) 300 that the ego vehicle 200 is within the geo-fenced area and is near the parking area, and in response, the server(s) 300 can transmit the parking availability data 122 to the ego vehicle 200 and/or the parking assistance module(s) 130. The server(s) 300 can broadcast the parking availability data 122 within the predetermined distance of the parking area. Such broadcasting can be performed continuously, periodically, irregularly, or even randomly. In such a case, when the ego vehicle 200 is within the predetermined distance, the ego vehicle 200 can receive the broadcasted parking availability data 122. In some instances, the server(s) 300 can be located in or near the parking area.

The parking assistance module(s) 130 can receive at least a portion of the parking availability data 122. In one or more arrangements, the parking assistance module(s) 130 can receive parking availability data 122 for one or more levels of a multi-level parking area. In one example, upon the ego vehicle 200 approaching the parking area, the parking assistance module(s) 130 can receive parking availability data 122 for all the levels of the multi-level parking area or any subset of levels. In another example, the parking assistance module(s) 130 can receive parking availability data 122 for the level the ego vehicle 200 is currently on or is entering. In such a case and as an example, the parking area can include location sensors at entry locations, ramps and/or exit locations. Upon the ego vehicle 200 traversing an entry location to first level and triggering a location sensor, the parking assistance module(s) 130 can receive the parking availability data for the first level. Upon the ego vehicle 200 traversing an exit location from the first level, an entry location or ramp to a second level, and/or triggering a location sensor, the parking assistance module(s) 130 can receive the parking availability data 122 for the second level. In one or more arrangements, the parking assistance module(s) 130 can receive the parking availability data 122 at regular, irregular, or random intervals. Additionally or alternatively, the parking assistance module(s) 130 can receive the parking availability data 122 when the parking availability data 122 is updated or at any suitable time.

The parking assistance module(s) 130 can be configured to receive the environment data 124 acquired by the sensors(s) of the connected vehicle(s) in the parking area. As an example, the parking assistance module(s) 130 can request the environment data from the sensor(s) and/or the data store(s) 120 of the connected vehicle(s). In response to the request, the connected vehicle(s) can transmit the environment data 124 to the parking assistance module(s) 130.

The parking assistance module(s) 130 can be configured to determine a current location of the ego vehicle 200 within the parking area based on at least the parking availability data 122 and the environment data 124. In one or more arrangements, the parking assistance module(s) 130 can align the environment data 124 to data in the parking availability data 122 to determine the current location of the ego vehicle 200. In such a case, the parking assistance module(s) 130 can analyze the parking availability data 122 and/or the environment data 124 to identify objects detected therein. The parking assistance module(s) 130 can use any suitable technique, including, for example, template matching and other kinds of computer vision and/or image processing techniques and/or other artificial or computational intelligence algorithms or machine learning methods. The parking assistance module(s) 130 can include any suitable object recognition software.

In one or more arrangements, the parking assistance module(s) 130 can be configured to identify landmarks and objects in the parking availability data 122. The parking assistance module(s) 130 can identify landmarks and objects in the environment data 124. The parking assistance module(s) 130 can match landmarks in the environment data 124 to the landmarks in the parking availability data 122. Further, the parking assistance module(s) 130 can match objects in the environment data 124 to the objects in the parking availability data 122. For instance, images in the environment data 124 captured by vehicle sensor(s), such as cameras, can be compared to images in the parking availability data 122 for possible matches based on shape, size, color, and/or orientation. Alternatively or in addition, measurements or other aspects of an image in the environment data 124 can be compared to measurements or other aspects of any images in the parking availability data 122. The parking assistance module(s) 130 can compare and determine if there is a match between an image in environment data 124 and an image in the parking availability data 122. “Match” or “matches” means that an image or other information collected by the sensor(s) and an image or other information in the parking availability data are substantially identical. The parking assistance module(s) 130 can accommodate minor inconsistencies between the environment data 124 and the parking availability data 122. For instance, an image or other information in the environment data 124 collected by the sensor(s) and an image in the parking availability data 122 can match within a predetermined probability (e.g., at least about 85%, at least about 90%, at least about 95% or greater) or confidence level. In one or more arrangements, the attributes of a detected parked vehicle in the environment data 124 can be compared to attributes of a parked vehicle identified in the parking availability data 122. As an example, the vehicle color, vehicle type, vehicle make and model, orientation, parking space identifier, and/or vehicle license plate number of the detected parked vehicle in the environment data 124 can be compared and/or matched to the vehicle color, vehicle type, vehicle make and model, orientation, parking space identifier, and/or vehicle license plate number of the parked vehicle identified in the parking availability data 122, respectively. The more attributes that are compared between the environment data and the parking availability data, the higher the confidence level.

The parking assistance module(s) 130 can determine the current location of the ego vehicle 200 relative to the environment using environment data acquired one or more vehicle sensors. As an example, radar sensors onboard the ego vehicle 200 can be configured to measure the distance between detected objects and the ego vehicle 200. The parking assistance module(s) 130 can align the environment data 124 with the parking availability data 122 by overlaying the objects in the parking availability data 122 with the matched objects in the environment data 124. Upon aligning the parking availability data 122 with the environment data 124, the parking assistance module(s) 130 can determine the current location of the ego vehicle 200 relative to the parking availability data and/or the parking area.

The parking assistance module(s) 130 can be configured to determine one or more available parking spaces in the parking area. The parking assistance module(s) 130 can determine the available parking spaces based on the identified vacant parking spaces and the parking restrictions associated with the identified vacant parking spaces in the parking availability data. The parking assistance module(s) 130 can compare characteristics of the ego vehicle 200 to any restrictions of the identified vacant parking spaces. As an example, the characteristics of the ego vehicle 200 can include a handicap designation and/or an electric vehicle designation. As another example, the ego vehicle 200 can be a small-sized vehicle that can fit into small cars only parking spaces.

The parking assistance module(s) 130 can determine the available parking spaces based on environment data 124 acquired by the vehicle sensor(s). The parking assistance module(s) 130 can determine whether a parking space is available based on detecting whether the parking space is vacant and whether there are any markings indicating parking restrictions that prevent the ego vehicle 200 from parking in the parking space.

The parking assistance module(s) 130 can be configured to navigate the ego vehicle 200 to one or more available parking spaces. In one or more arrangements, upon identifying an available parking space, the parking assistance module(s) 130 can determine a route from the current location of the ego vehicle 200 to the available parking space. The parking assistance module(s) 130 can determine the route and/or driving instructions based on the location of the available parking space and the driving rules within the parking area using any suitable navigation device. In a case where the ego vehicle 200 is being manually driven, the parking assistance module(s) 130 can output the route and/or driving directions to the driver using a display and/or an audio device. In a case where the ego vehicle 200 is an autonomous vehicle, the parking assistance module(s) 130 can transmit the route and/or driving instructions to one or more vehicle systems in the ego vehicle 200 such as the autonomous driving module(s).

The parking assistance module(s) 130 can be configured to cause the parking availability data 122 to be updated based on at least one of a parking space of the ego vehicle 200 and the environment data 124. In one or more arrangements, as the ego vehicle 200 drives within the parking area, the parking assistance module(s) 130 can periodically compare the attributes of detected parked vehicles to the attributes of parked vehicles identified in the parking availability data 122. In a case where the parking assistance module(s) 130 has determined the current location of the ego vehicle 200 and one or more of the attributes of the parked vehicles detected by the vehicle sensors at the current location do not match the attributes of the parked vehicles in the parking availability data 122, the parking assistance module(s) 130 can update the parking availability data 122 with the attributes of the detected parked vehicles, or the parking assistance module(s) 130 can cause the parking availability data 122 to be updated. In a case where the ego vehicle 200 has driven into and parked in a parking space, the parking assistance module(s) 130 can update the parking availability data 122 or cause the parking availability data 122 to be updated to indicate that the parking space has become occupied. The parking assistance module(s) 130 can include the attributes of the ego vehicle 200 in the update. In the case where the parking assistance module(s) 130 is powered by a power source within the ego vehicle 200, the parking assistance module(s) 130 can update the parking availability data 122 before the ego vehicle 200 is turned off. In a case where the ego vehicle 200 is leaving the parking area and has exited the parking space, the parking assistance module(s) 130 can update the parking availability data 122 to indicate that the parking space which was occupied by the ego vehicle 200 has become vacant.

The parking assistance module(s) 130 can be configured to transmit the updated parking availability data 122 to the server(s) 300 or one or more connected vehicle(s). In one or more arrangements, the parking assistance module(s) 130 can transmit the updated parking availability data 122 to any interested entity using any suitable communication method(s). The parking assistance module(s) 130 can transmit the updated parking availability data 122 to the data store(s). In the case that the parking assistance module(s) 130 is in the ego vehicle 200, the parking assistance module(s) 130 can transmit the parking availability data 122 to the server and/or another vehicle via the communication network(s).

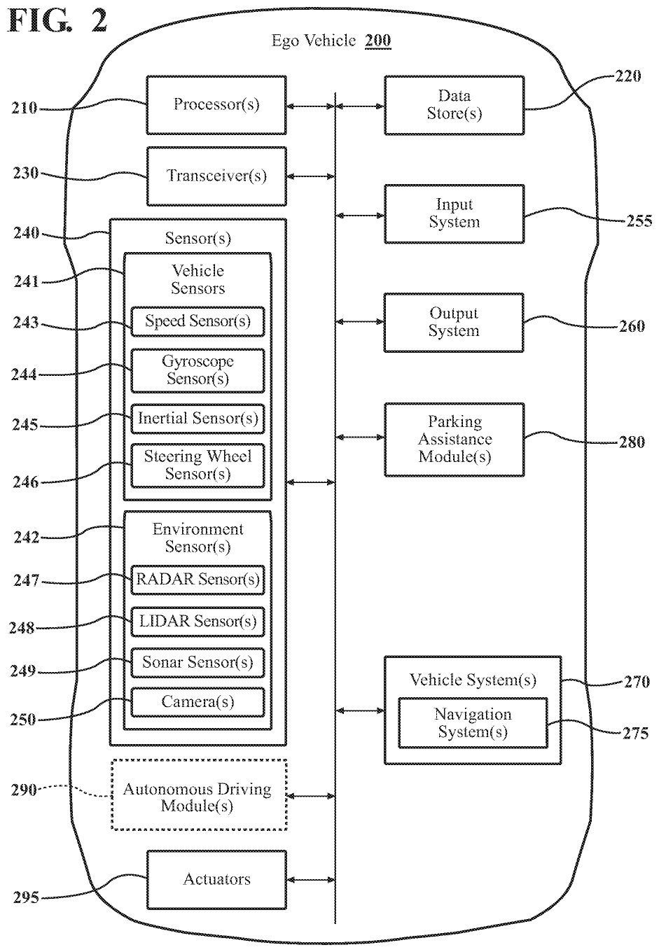

The parking assistance module(s) 130 can be configured to navigate the ego vehicle 200 to an available parking space. Upon identifying the available parking space, the parking assistance module(s) 130 can determine a route from the current location of the ego vehicle 200 to the available parking space. The parking assistance module(s) 130 can determine the route and/or driving instructions based on the location of the available parking space and the driving rules within the parking area using any suitable navigation device. In a case where the ego vehicle 200 is being manually driven, the parking assistance module(s) 130 can output the route and/or driving directions to the driver using a display, an audio device, or other element of an output system 260 (FIG. 2) of the ego vehicle 200. In a case where the ego vehicle 200 is an autonomous vehicle, the parking assistance module(s) 130 can transmit the route and/or driving instructions to one or more vehicle systems 270 in the ego vehicle 200 and/or one or more autonomous driving modules 290.

It should be noted that, in some arrangements, the processor(s) 110, the data store(s) 120, and/or the parking assistance module(s) 130 can be located on the ego vehicle 200. In one or more arrangements, the processor(s) 110, the data store(s) 120, and/or the parking assistance module(s) 130 can be located on the server(s) 300. In some arrangements, the processor(s) 110, the data store(s) 120, and/or the parking assistance module(s) 130 can be located on both the ego vehicle 200 and the server(s) 300, or any combination thereof. In some arrangements, the processor(s) 110, the data store(s) 120, and/or the parking assistance module(s) 130 can be located remote from the ego vehicle 200 and/or the server 300. In one or more arrangements, the processor(s) 110, the data store(s) 120, and/or the parking assistance module(s) 130 can be located at or near the parking area.

The ego vehicle 200 will now be described in greater detail. Referring to FIG. 2, an example of the ego vehicle 200 is shown. In some instances, the ego vehicle 200 can be an autonomous vehicle. As used herein, “autonomous vehicle” means a vehicle that is configured to operate in an autonomous operational mode. “Autonomous operational mode” means that one or more computing systems are used to navigate and/or maneuver the vehicle along a travel route with minimal or no input from a human driver. In one or more arrangements, the ego vehicle 200 can be highly or fully automated. In some arrangements, the ego vehicle 200 can be a semi-autonomous vehicle or a manually operated vehicle.

The ego vehicle 200 can include one or more processors 210 and one or more data stores 220. The above-discussion of the processor(s) 110 and the data store(s) 120 applies equally to the processor(s) 210 and the data store(s) 220, respectively.

The ego vehicle 200 can include one or more transceivers 230. As used herein, “transceiver” is defined as a component or a group of components that transmit signals, receive signals, or transmit and receive signals, whether wirelessly or through a hard-wired connection. The transceiver(s) 230 can enable communications between the ego vehicle 200 and other elements of the parking assistance system 100. The transceiver(s) 230 can be any suitable transceivers used to access a network, access point, node or other device for the transmission and receipt of data. The transceiver(s) 230 may be wireless transceivers using any one of a number of wireless technologies, now known or in the future.

The ego vehicle 200 can include one or more sensors 240. “Sensor” means any device, component and/or system that can detect, determine, assess, monitor, measure, quantify, acquire, and/or sense something. The one or more sensors can detect, determine, assess, monitor, measure, quantify, acquire, and/or sense in real-time. As used herein, the term “real-time” means a level of processing responsiveness that a user or system senses as sufficiently immediate for a particular process or determination to be made, or that enables the processor to keep up with some external process. Data acquired by the one or more sensors 240 can be stored in the data store(s) 220.

In arrangements in which the ego vehicle 200 includes a plurality of sensors 240, the sensors 240 can work independently from each other. Alternatively, two or more of the sensors can work in combination with each other. In such case, the two or more sensors can form a sensor network. The one or more sensors can be operatively connected to the processor(s) 210, the data store(s) 220, and/or other element of the ego vehicle 200.

The sensor(s) 240 can include any suitable type of sensor. Various examples of different types of sensors will be described herein. However, it will be understood that the embodiments are not limited to the particular sensors described.

The sensor(s) can include one or more vehicle sensors 241. The vehicle sensor(s) 241 can detect, determine, assess, monitor, measure, quantify and/or sense information about the ego vehicle 200 itself. The vehicle sensor(s) 241 can be used to determine the location and/or the position of the ego vehicle 200. For instance, the vehicle sensors 241 can include one or more speed sensors 243 that detects the speed, acceleration, and/or deceleration of the ego vehicle 200. The vehicle sensor(s) 241 can include one or more gyroscope sensors 244 that can measure yaw rates of the ego vehicle 200 and estimate the orientation of the ego vehicle 200 based on the yaw rate measurements. The vehicle sensor(s) 241 can include one or more inertial sensors 245 that can detect landmarks such as speed bumps and corners which can be used to estimate the location and/or the position of the ego vehicle 200. The vehicle sensor(s) 241 can include one or more steering wheel sensors 246 that can detect steering angle(s) and turn angle(s) of the ego vehicle 200. The speed sensor measurements may be integrated over time to estimate the ego vehicle's 200 displacement, while the yaw rate and/or steering angle measurements may be used to estimate changes in the ego vehicle's 200 heading angle.

Alternatively or in addition, the sensor(s) 240 can include one or more environment sensors 242 configured to detect, determine, assess, monitor, measure, quantify, acquire, and/or sense environment data 124. “Environment data” includes data and/or information about the external environment in which the ego vehicle 200 is located or one or more portions thereof. The environment data 124 can include at least a portion of the parking area. For example, the environment sensor(s) 242 can detect, determine, assess, monitor, measure, quantify, acquire, and/or sense objects in at least a portion of the parking area and/or information/data about such objects. Such objects may be stationary objects and/or dynamic objects. The environment sensors 242 can detect, determine, assess, monitor, measure, quantify, acquire, and/or sense other things in the parking area, such as, for example, moving vehicles, parked vehicles, lane markers, floor level indicators, signs, traffic lights, traffic signs, lane lines, crosswalks, etc.

In one or more arrangements, the environment sensor(s) 242 can include one or more radar sensors 247, one or more lidar sensors 248, one or more sonar sensors 249, and/or one or more cameras 250. Such sensors can be used to detect, determine, assess, monitor, measure, quantify, acquire, and/or sense, directly or indirectly, something about the external environment of the ego vehicle 200. For instance, one or more of the environment sensors 242 can be used to detect, determine, assess, monitor, measure, quantify, acquire, and/or sense, directly or indirectly, the presence of one or more objects in the external environment of the ego vehicle 200, the position or location of each detected object relative to the ego vehicle 200, the distance between each detected object and the ego vehicle 200 in one or more directions (e.g. in a longitudinal direction, a lateral direction, and/or other direction(s)), the elevation of a detected object, the speed of a detected object, the acceleration of a detected object, the heading angle of a detected object, and/or the movement of each detected obstacle.

The ego vehicle 200 can include an input system 255. An “input system” includes any device, component, system, element or arrangement or groups thereof that enable information/data to be entered into a machine. The input system 255 can receive an input from a vehicle occupant (e.g. a driver or a passenger). Any suitable input system 255 can be used, including, for example, a keypad, display, touch screen, multi-touch screen, button, joystick, mouse, trackball, microphone and/or combinations thereof.

The ego vehicle 200 can include an output system 260. An “output system” includes any device, component, system, element or arrangement or groups thereof that enable information/data to be presented to a vehicle occupant (e.g. a person, a vehicle occupant, etc.). The output system 260 can present information/data to a vehicle occupant. The output system 260 can include a display. Alternatively or in addition, the output system 260 may include an earphone and/or speaker. In one or more arrangements, the parking assistance module(s) 130 can output the route and/or driving directions to the driver using the output system 260. Some components of the ego vehicle 200 may serve as both a component of the input system 255 and a component of the output system 260.

The ego vehicle 200 can include one or more vehicle systems 270. The one or more vehicle systems 270 can include a propulsion system, a braking system, a steering system, throttle system, a transmission system, a signaling system, and/or a navigation system 275. Each of these systems can include one or more mechanisms, devices, elements, components, systems, and/or combination thereof, now known or later developed. The above examples of the vehicle systems 270 are non-limiting. Indeed, it will be understood that the vehicle systems 270 can include more, fewer, or different vehicle systems. It should be appreciated that although particular vehicle systems are separately defined, each or any of the systems or portions thereof may be otherwise combined or segregated via hardware and/or software within the ego vehicle 200.

The navigation system 275 can include one or more mechanisms, devices, elements, components, systems, applications and/or combinations thereof, now known or later developed, configured to determine the geographic location of the ego vehicle 200 and/or to determine a travel route for the ego vehicle 200. The navigation system 275 can include one or more mapping applications to determine a travel route for the ego vehicle 200. The navigation system 275 can include a global positioning system, a local positioning system, or a geolocation system.

The ego vehicle 200 can include one or more modules, at least some of which will be described herein. The modules can be implemented as computer readable program code that, when executed by a processor, implement one or more of the various processes described herein. One or more of the modules can be a component of the processor(s) 210, or one or more of the modules can be executed on and/or distributed among other processing systems to which the processor(s) 210 is operatively connected. The modules can include instructions (e.g., program logic) executable by one or more processor(s) 210. Alternatively or in addition, one or more data store 220 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

The ego vehicle 200 can include one or more parking assistance modules 280. The above-discussion of the parking assistance module(s) 130 in connection with FIG. 1 applies equally here.

In some arrangements, the ego vehicle 200 can include one or more autonomous driving modules 290. The autonomous driving module(s) 290 can determine travel path(s), current autonomous driving maneuvers for the ego vehicle 200, future autonomous driving maneuvers and/or modifications to current autonomous driving maneuvers based on data acquired by the sensor(s) 240, driving scene models, and/or data from any other suitable source. “Driving maneuver” means one or more actions that affect the movement of a vehicle. Examples of driving maneuvers include: accelerating, decelerating, braking, turning, moving in a lateral direction of the ego vehicle 200, changing travel lanes, merging into a travel lane, and/or reversing, just to name a few possibilities. The autonomous driving module(s) 290 can cause, directly or indirectly, such autonomous driving maneuvers to be implemented. As used herein, “cause” or “causing” means to make, force, compel, direct, command, instruct, and/or enable an event or action to occur or at least be in a state where such event or action may occur, either in a direct or indirect manner. The autonomous driving module(s) 290 can execute various vehicle functions and/or to transmit data to, receive data from, interact with, and/or control the ego vehicle 200 or one or more systems thereof (e.g. one or more of vehicle systems 270).

The ego vehicle 200 can include one or more actuators 295 to modify, adjust and/or alter one or more of the vehicle systems 270 or components thereof to responsive to receiving signals or other inputs from the processor(s) 210 and/or the autonomous driving module(s) 290. The actuators 295 can include motors, pneumatic actuators, hydraulic pistons, relays, solenoids, and/or piezoelectric actuators, just to name a few possibilities.

The processor(s) 210 and/or the autonomous driving module(s) 290 can be operatively connected to communicate with the various vehicle systems 270 and/or individual components thereof. Further, the processor(s) 210 and/or the autonomous driving module(s) 290 can be in communication to send and/or receive information from the various vehicle systems 270 to control the movement, speed, maneuvering, heading, direction, etc. of the ego vehicle 200. The processor(s) 210 and/or the autonomous driving module(s) 290 may control some or all of these vehicle systems 270 and, thus, may be partially or fully autonomous.

For instance, when operating in an autonomous mode, the processor(s) 210 and/or the autonomous driving module(s) 290 can control the direction and/or speed of the ego vehicle 200. The processor(s) 210 and/or the autonomous driving module(s) 290 can cause the ego vehicle 200 to accelerate (e.g., by increasing the supply of fuel provided to the engine), decelerate (e.g., by decreasing the supply of fuel to the engine and/or by applying brakes) and/or change direction (e.g., by turning the front two wheels). The above description of the ego vehicle 200 and the elements in the ego vehicle 200 can apply equally to the connected vehicle(s) 140 and elements within the connected vehicle(s) 140.

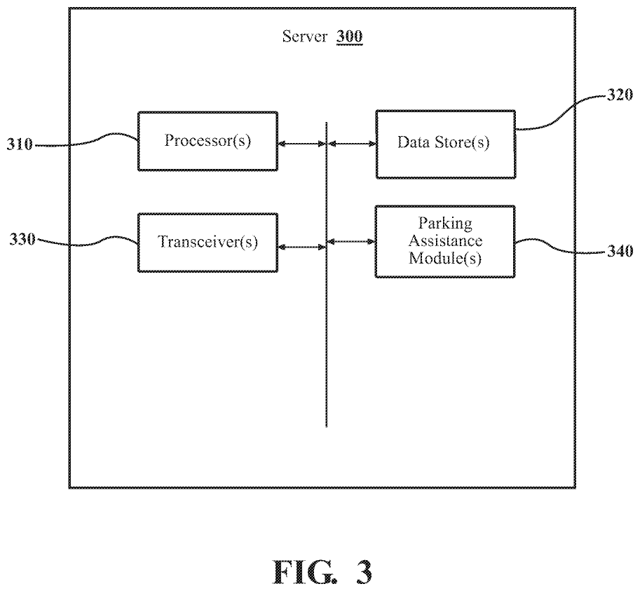

Referring to FIG. 3, an example of a server 300 is shown. The server 300 can include one or more processors 310, one or more data stores 320, one or more transceivers 330, and/or one or more parking assistance modules 340. The above description of the one or more processors 110, the one or more data stores 120, and the one or more parking assistance modules 130 in connection with the parking assistance system 100 of FIG. 1 applies equally to the respective elements of the server 300. Likewise, the above description of the processor(s) 210, the data store(s) 220, and the transceiver(s) 230 in connection with the ego vehicle 200 applies equally to the respective elements of the server 300.

Now that the various potential systems, devices, elements and/or components of the parking assistance system 100 have been described, various methods will now be described. Various possible steps of such methods will now be described. The methods described may be applicable to the arrangements described above, but it is understood that the methods can be carried out with other suitable systems and arrangements. Moreover, the methods may include other steps that are not shown here, and in fact, the methods are not limited to including every step shown. The blocks that are illustrated here as part of the methods are not limited to the particular chronological order. Indeed, some of the blocks may be performed in a different order than what is shown and/or at least some of the blocks shown can occur simultaneously.

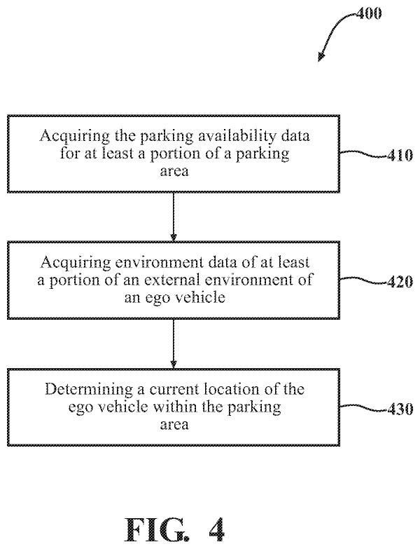

Turning to FIG. 4, an example of a parking assistance method 400 is shown. At block 410, parking availability data 122 can be acquired for at least a portion of a parking area. The parking availability data 122 can be acquired by the ego vehicle 200 and/or the server 300. The method 400 can continue to block 420.

At block 420, environment data 124 of at least a portion of an external environment of the ego vehicle 200 can be acquired. The environment data 124 can include data about at least a portion of the parking area. The environment data 124 can be acquired by the ego vehicle 200 (e.g., by the sensor(s) 240) and/or the server 300 (e.g., as received from connected vehicle(s) 140 and/or the ego vehicle 200). The method 400 can continue to block 430.

At block 430, the parking availability data 122 and the environment data 124 can be analyzed to determine the current location of the ego vehicle 200 within the parking area. The current location of the ego vehicle 200 can be determined by the parking assistance module(s) 130 and/or the processor(s) 110.

The method 400 can end. Alternatively, the method 400 can return to block 410 or some other block. The method 400 can be repeated at any suitable point, such as at a suitable time or upon the occurrence of any suitable event or condition.

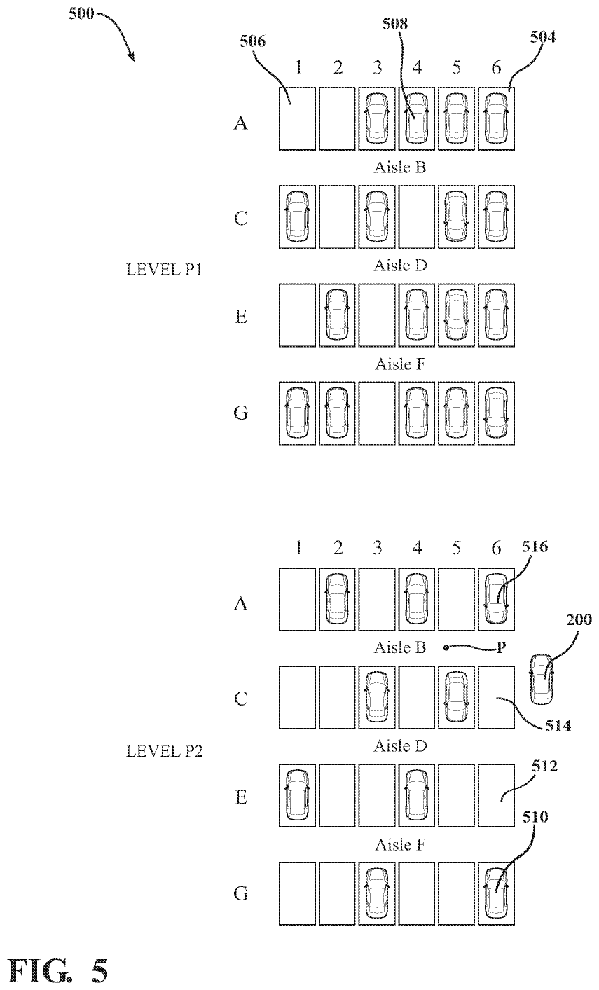

A non-limiting example of the operation of the PA system 100 and/or one or more of the methods will now be described in relation to FIG. 5. FIG. 5 shows an example of a parking assistance scenario 500 in which an ego vehicle 200 navigates a multi-level parking area in search of an available parking space. The parking area includes two levels, P1 and P2.

Upon the ego vehicle 200 approaching the parking area, the parking assistance module(s) 130 can receive the parking availability data 122 for both levels P1 and P2 of the parking area from the server 300 and/or a database associated with the parking area. The parking availability data 122 can be in a map form. In some instances, the map form can be similar to the overhead depiction of the parking assistance scenario 500 shown in FIG. 5. The parking availability data 122 can include marked parking spaces, where an occupied parking space 504 can be shown with a vehicle in the parking space and a vacant space 506 can be shown free of any vehicle(s).

The parking availability data 122 can include additional information about the parked vehicles in the occupied parking spaces. As an example and as shown, the parking availability data 122 can illustrate the parked vehicle(s) with a graphical representation of the parked vehicle 508, indicating the color of the parked vehicle and the direction the parked vehicle is facing.

As shown, from its direction of travel, the ego vehicle 200 can acquire environment data 124 that can include data indicating a parking space occupied by a yellow vehicle 510 that is forward-facing, followed by two vacant parking spaces 512, 514 and then, a parking space occupied by a white vehicle 516 that is backward-facing. As the ego vehicle 200 turns left into aisle B on Level P2, the parking assistance module(s) 130 can acquire environment data 124 that can include data indicating the sequence of <vacant, occupied, vacant, occupied, vacant, vacant> to the left of the ego vehicle 200 and the sequence of <occupied, vacant, occupied, vacant, occupied, vacant> to the right of the ego vehicle 200. The parking assistance module(s) 130 can compare the environment data 124 to the parking availability data 122 and determine the aisle in the parking availability data 122 that matches the detected sequences in the environment data 124. The parking assistance module(s) 130 can determine that the detected sequences match aisle B of Level P2 and not aisles D or F of Level P2, for instance.

The parking assistance module(s) 130 can acquire environment data 124 that can include data identifying attributes of the parked vehicle(s) to pinpoint the position of the ego vehicle 200. In this example, a sequence on the left side of the ego vehicle 200 can be <vacant 514, (occupied, black, backward), vacant> and a sequence on the right side of the ego vehicle 200 can be <(occupied, white, backward) 516, vacant, (occupied, red, forward)>. The parking assistance module(s) 130 can compare the environment data 124 to the parking availability data 122 and determine that the ego vehicle 200 is at point P based on the detected sequences.

The parking assistance module(s) 130 can continually verify the location of the ego vehicle 200 by comparing the vacant parking spaces, occupied parking spaces, and the parked vehicles detected in rows A, C to the vacant parking spaces and parked vehicles in the related rows in the parking availability data. In the case where there is a mismatch, the parking assistance module(s) 130 can determine a confidence level in the parking space information and/or attributes of parked vehicles in the environment data 124, and if the confidence level meets or exceeds a predetermined threshold, the parking assistance module(s) 130 can send an update to the server 300. In the case that the confidence level is not met or exceeded, the parking assistance module(s) 130 does not send an update to the server 300.

As an example, the parking assistance module(s) 130 can identify a parking space ahead (e.g., A1, A3, A5, C1, C2, C4) of the ego vehicle 200, notify the ego vehicle 200 of the identified space(s), and provide routing information to the identified space(s). Upon determining the current location of the ego vehicle 200 to be at point P, the parking assistance module(s) 130 can receive additional environment data 124 from the steering sensor(s) and/or the inertial sensor(s) that indicates that the ego vehicle 200 has turned into a parking space. The parking assistance module(s) 130 can send an update to the server 300 that a previously vacant parking space has become occupied.

It will be appreciated that arrangements described herein can provide numerous benefits, including one or more of the benefits mentioned herein. For example, arrangements described herein can facilitate finding and navigating to an available parking space. Arrangements described herein can enable a driver and/or an autonomous vehicle to navigate a parking area in a much safer and smoother manner. Arrangements described herein can enable a driver and/or an autonomous vehicle to determine what level of a parking area the driver and/or vehicle is on. Arrangements described herein can provide drivers and/or autonomous vehicles with important information about the parking area such as speed limits and restricted areas. Arrangements described herein can take advantage of vehicle-to-cloud (V2C) communication. Arrangements described herein can result in all of the computing processes to be conducted on a server and/or an ego vehicle 200. Further, in instances in which computations are performed on a remote server, the arrangements described herein can be quickly and easily migrated to any mass produced vehicle. Arrangements described herein can improve safety, mobility, and sustainability within a parking area. Arrangements described herein can ensure that a parking availability map is updated based on real-time conditions. By matching real-time environment data with a parking availability map, arrangements described herein can reduce errors in the estimated vehicle positions due to measurement noise and the failure of map matching. In addition, the computational overhead and the storage space to maintain the reference features can be reduced.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied or embedded, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object oriented programming language such as Java™ Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

As used herein, the term “substantially” or “about” includes exactly the term it modifies and slight variations therefrom. Thus, the term “substantially parallel” means exactly parallel and slight variations therefrom. “Slight variations therefrom” can include within 15 degrees/percent/units or less, within 14 degrees/percent/units or less, within 13 degrees/percent/units or less, within 12 degrees/percent/units or less, within 11 degrees/percent/units or less, within 10 degrees/percent/units or less, within 9 degrees/percent/units or less, within 8 degrees/percent/units or less, within 7 degrees/percent/units or less, within 6 degrees/percent/units or less, within 5 degrees/percent/units or less, within 4 degrees/percent/units or less, within 3 degrees/percent/units or less, within 2 degrees/percent/units or less, or within 1 degree/percent/unit or less. In some instances, “substantially” can include being within normal manufacturing tolerances.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope of the invention.

What is claimed is:

1. A parking assistance method, the method comprising:
acquiring parking availability data for at least a portion of a parking area, the parking availability data including data about a plurality of parking spaces and data about one or more vehicles parked in one or more of the plurality of parking spaces, the parking availability data further including one or more attributes of the one or more vehicles parked in the one or more of the plurality of parking spaces;
acquiring, using one or more sensors, environment data of at least a portion of an external environment of an ego vehicle, the external environment including at least a portion of the parking area; and
determining a current location of the ego vehicle within the parking area based on at least the parking availability data and the environment data.

2. The parking assistance method of claim 1, wherein the one or more attributes include one or more of: a vehicle parking space identifier, a vehicle color, a vehicle type, a vehicle make, a vehicle model, a vehicle orientation, and a vehicle license plate number.

3. The parking assistance method of claim 1, further including:
determining one or more available parking spaces in the parking area.

4. The parking assistance method of claim 3, further including:
navigating the ego vehicle to one of the one or more available parking spaces.

5. The parking assistance method of claim 1, further including:
causing the parking availability data to be updated based on at least one of a parking space of the ego vehicle and the environment data.

6. The parking assistance method of claim 5, further including:
transmitting the updated parking availability data to a server or another vehicle.

7. The parking assistance method of claim 1, wherein acquiring the parking availability data further includes:
determining whether the ego vehicle is within a predetermined distance of the parking area; and
acquiring the parking availability data in response to the ego vehicle 200 being within the predetermined distance.

8. The parking assistance method of claim 1, wherein determining the current location of the ego vehicle based on at least the parking availability data and the environment data includes:
aligning the environment data to data in the parking availability data to determine the current location of the ego vehicle.

9. The parking assistance method of claim 1, wherein aligning the environment data to data in the parking availability data to determine the current location of the vehicle includes:
comparing one or more attributes of one or more vehicles identified in the environment data to the one or more attributes of the one or more vehicles parked in the one or more of the plurality of parking spaces in the parking availability data.

10. The parking assistance method of claim 1, wherein the parking availability data is a map.

11. The parking assistance method of claim 1, wherein the parking availability data includes at least one environment landmark.

12. A parking assistance system, the system comprising:
one or more sensors, the one or more sensors being configured to acquire environment data of at least a portion of an external environment of an ego vehicle, the environment data including at least a portion of a parking area;
one or more processors, the one or more processors being programmed to initiate executable operations comprising:
acquiring parking availability data for at least a portion of the parking area, the parking availability data including data about a plurality of parking spaces and data about one or more vehicles parked in one or more of the plurality of parking spaces, the parking availability data further including one or more attributes of the one or more vehicles parked in the one or more of the plurality of parking spaces; and
determining a current location of the ego vehicle within the parking area based on at least the parking availability data and the environment data.

13. The parking assistance system of claim 12, wherein the one or more attributes include one or more of: a vehicle parking space identifier, a vehicle color, a vehicle type, a vehicle make, a vehicle model, a vehicle orientation, and a vehicle license plate number.

14. The parking assistance system of claim 12, wherein the executable operations further include:
determining one or more available parking spaces in the parking area.

15. The parking assistance system of claim 14, wherein the executable operations further include:
navigating the ego vehicle to one of the one or more available parking spaces.

16. The parking assistance system of claim 12, wherein the executable operations further include:
causing the parking availability data to be updated based on at least one of a parking space of the ego vehicle and the environment data.

17. The parking assistance system of claim 16, wherein the executable operations further include:
transmitting the updated parking availability data to a server or another vehicle.

18. The parking assistance system of claim 12, wherein acquiring the parking availability data further includes:
determining whether the ego vehicle is within a predetermined distance of the parking area; and
acquiring the parking availability data in response to the ego vehicle being within the predetermined distance.

19. The parking assistance system of claim 12, wherein determining the current location of the ego vehicle based on at least the parking availability data and the environment data includes:
aligning the environment data to data in the parking availability data to determine the current location of the vehicle.

20. The parking assistance system of claim 12, wherein aligning the environment data to data in the parking availability data to determine the current location of the vehicle includes:
comparing one or more attributes of one or more vehicles identified in the environment data to the one or more attributes of the one or more vehicles parked in the one or more of the plurality of parking spaces in the parking availability data.
